(19) United States
(12) Patent Application Publication
(10) Pub. No.: US 2010/0248674 A1
(43) Pub. Date: Sep. 30, 2010

(54) Switchable Mode Filter for Overlaid Signal Extraction in Noise

(75) Inventors: Howard Smith, Hertfordshire (GB); Stuart Strickland, Hertfordshire (GB); Stefan Fulga, Ottawa (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sige Semiconductor (Europe) Limited, Bishop's Stortford (GB)

(21) Appl. No.: 12/377,720

(22) PCT Filed: Aug. 17, 2007
(86) PCT No.: PCT/CA07/01415

§ 371 Date: May 5, 2010

Related U.S. Application Data
(60) Provisional application No. 60/838,150, filed on Aug. 17, 2006.

(51) Int. Cl. H04B 1/10

(52) U.S. Cl. 455/296

(57) ABSTRACT

A method of extracting predetermined narrowband microwave signals having common transmission center frequency is presented through the teachings of the invention. In an embodiment of the invention a software based signal processing approach is employed to identify the microwave signals present and control an adaptive bandwidth filter to provide an approximately optimal transmission bandwidth of the adaptive bandwidth filter for the selected microwave signal and minimized noise into the correlation process.

### FIELD OF THE INVENTION

The invention relates generally to signal extraction and more particularly to automated setting of filters for signal extraction.

### BACKGROUND OF THE INVENTION

In recent years, the use of wireless and RF technology has increased dramatically in portable and hand-held units, where such units are deployed by a variety of individuals from soldiers on the battlefield to a mother searching for her daughter's friend's house. The uses of wireless technology are widespread, increasing, and include but are not limited to telephony, Internet e-mail, Internet web browsers, global positioning, photography, and in-store navigation.

Within each hand-held or portable wireless device there is a highly sensitive chain of RF electronics providing both the transmission and receiver functions. These circuits not only directly manipulate the RF signal, for example by amplification, attenuation, mixing or detection, but also provide ancillary functions such as power monitoring, signal identification, and control. Additionally these functions may be undertaken post-mixing, such that the signals are at a lower frequency than the original received signal, typically called the IF or Intermediate Frequency. The latter may include, for example, the extraction of digitally encoded voice signals from a carrier in cellular telephony, analog signal extraction from a high frequency microwave carrier in military applications, or digital signal extraction from microwave carriers for global positioning.

Commonly, the receiver at the front-end of this highly sensitive chain of RF electronics employs a filter to limit frequency bandwidth, in order to limit exposure to RF signals other than the intended signal(s) or to limit the noise present within the processed signals when searching for RF signals. However, this becomes problematic when two specifically sought signals are present within a same limited portion of the microwave spectrum. This may be further exacerbated if the signals being extracted are deeply embedded into the general microwave background. Such an example is present within the terminal equipment of global navigation satellite systems (GNSS) such as today's generations of GPS and planned evolutions, including the European Union's Galileo platform.

Within these the location information is provided from the GNSS as encoded information upon the microwave carrier and is digitized before the data is sent to the digital signal-processing (DSP) unit. The location information being extracted by firstly executing a set of digital signal processing functions to extract the useful GNSS information. The processing power required to extract this information therefore is typically inversely proportional to the difference in signal strength between the noise floor and the received signal to be extracted. Hence, if the electrical noise floor is at, for example, −130 dBm, and the desired signal is at −160 dBm, then the processing power needed to extract the useful information is higher than if the signal is at −150 dBm.

Typically the DSP includes digital correlators, as the information being extracted is of a predetermined form, and is known to be embedded deeply into noise due to the design of the GNSS system. The processing power required at the correlators depends on an amount of noise power arriving at the input port of the correlators. If this noise is band-limited, some higher frequency components of the noise are attenuated, then the processing power required to perform the correlation function is lower. Band limiting of this type is typically introduced by filtering out the lower and higher frequency components of the noise, using a band pass filter.

Typically the RF front-end of the GNSS receiver employs an analog-to-digital converter (ADC) to perform the front-end digitization, the sample rate of the ADC dictated by the given GNSS application and being typically within the range 13 Mb/s to 32 Mb/s. In order for this ADC to operate without either loss of data or aliasing of sampled data, the RF signal arriving at the input port of the ADC has to meet the Nyquist criteria. The Nyquist criterion establishes that the maximum frequency component of this signal has to be lower than half the sample rate frequency. To achieve this, there is generally inserted an anti-aliasing filter, this being analog in design. It is also possible for the same filter to perform noise-filtering functionality.

A current generation GPS receiver typically employs a single sideband receiver architecture that incorporates an image reject bandpass IF filter to select the GPS signals from the GNSS whilst also rejecting the demodulated image signals which result from the demodulation of the raw RF signal to an IF signal and other adjacent channel interference sources. The bandwidth of the bandpass IF filter for a typical GPS receiver is set at approximately 2 MHz to capture the centre and the first two lobes of the L1 band GPS signal.

Next generation systems, such as the independent GNSS proposed by the European Union (EU), the Galileo Positioning System which is simply referred to as Galileo, will share the same carrier frequency as the existing L1 band GPS satellites but will transmit on different spread spectrum distributions than the existing GPS signals. To capture such a variant spread spectrum distribution, an analog filter of the EU Galileo GNSS should be wider, at 4.4 MHz, than the approximately 2.2 MHz of existing GPS filters. Unlike other multiple standard wireless systems such as cellular telephones operating on the GPRS and GSM standards with four frequency regimes, 850 MHz, 950 MHz, 1850 MHz and 1950 MHz, the GNSS platforms are intended to use different transmission schemes on the same 1575.42 MHz carrier. As such it would be advantageous to exploit a single RF chain of electronics for low cost GNSS devices compatible with both systems rather than multiple parallel chains deployed within such quad-band cellular telephones.

A system using existing prior art solutions would be designed with a single RF chain and a filter optimally configured to either one or other of the two GNSS standards, and hence limited to the selected GNSS platform, or would have a compromised filter bandwidth to support both standards. Such a compromised filter bandwidth delivering less than optimal performance in any mode of operation.

For example, a hardware filter set at 4.4 MHz for the EU Galileo platform when receiving GPS signals will also allow additional interference to enter the receiver system and thereby reduce the sensitivity of the system to the desired GPS signals. If the hardware design were fixed at a narrower bandwidth to avoid comprising GPS performance, then much of the power of the Galileo signals would not be captured, either limiting the dynamic range of the instrument or significantly increasing power consumption to perform the correlations etc as discussed supra.

It would be advantageous for a dual mode bandpass IF filter to be provided within a single RF chain, and further advantageous for the mode of operation of the filter to be established under software control of the GNSS receiver itself.

It would be further advantageous if the software configuration were derived based upon a preliminary correlation of a received GNSS signal such that the GNSS receiver either defaulted to one system or provided a user with a selection option when both were present. In the absence of signals conforming to the EU Galileo specification, the receiver filter can be advantageously adjusted in software to a narrower bandwidth optimal for receiving GPS signals. In the presence of signals from both GPS and Galileo, the filter bandwidth can be widened to capture both with a modest compromise in the GPS performance. In the absence of GPS signals, the filter bandwidth could be widened still further to capture more of the power of the Galileo transmissions. These adjustments can be performed dynamically in software and may optionally be selected in accordance with broader search and acquisition strategies of the GNSS receiver system.

### SUMMARY OF THE INVENTION

In accordance with the invention there is provided a method of reducing noise within a microwave receiver comprising providing an input port, the input port for receiving a microwave spectrum being noise dominated, and providing an output port, the output port for providing a modified microwave spectrum with substantially reduced noise. An adaptive bandwidth filter is provided; the adaptive bandwidth filter being coupled between the input port and output port, having at least a control port, being characterized by providing a variable passband bandwidth between predetermined minimum and maximum values and having the variable passband bandwidth being essentially at constant centre frequency. Wherein a control signal is provided to the at least a control port for establishing the variable passband bandwidth of the adaptive bandwidth filter.

According to another embodiment of the invention a circuit for isolating very low level signals within a microwave receiver comprising an input port, the input port for receiving a microwave spectrum being noise dominated; an output port, the output port for providing a modified microwave spectrum with substantially reduced noise; an adaptive bandwidth filter; the adaptive bandwidth filter being coupled between the input port and output port, having at least a control port, the adaptive bandwidth filter being characterized by providing a variable passband bandwidth between predetermined minimum and maximum values and having the variable passband bandwidth being essentially at constant centre frequency; coupling a control signal to the at least a control port; wherein the control signal for establishing the variable passband bandwidth of the adaptive bandwidth filter at a passband bandwidth associated with at least a magnitude of the applied control.

According to another embodiment of the invention a method of recovering navigation signal information is achieved comprising; providing a microwave receiver; the microwave receiver for receiving RF signals over at least a predetermined bandwidth from a navigation beacon, the navigation beacon providing a characteristic navigation signal which is typically of lower signal strength than the background noise power incident upon the microwave receiver; providing an adaptive microwave filter; the adaptive microwave filter being electrically coupled to the microwave receiver and being further characterized additionally by having an output port and a control port, the adaptive microwave filter for providing a predetermined filter passband around a fixed centre frequency, the fixed centre frequency being that of the navigation signal, where the predetermined filter passband is determined from a control signal applied to the control port; and providing a digital signal processing unit for correlating the output of the adaptive microwave filter to determine at least a characteristic of the navigation signal; the digital signal processing unit for providing the control signal to the control port of the adaptive microwave filter.

According to another embodiment of the invention a software decision making process comprises the steps of

(a) passing a microwave signal through an adaptive passband filter, to provide a filtered microwave signal, the adaptive passband filter being characterized by at least one of a plurality of predetermined passband widths;
(b) correlating the filtered microwave signal with at least one predetermined characteristic of at least one of plurality of navigation signals;
(c) determining based upon the result of the correlation at least one of the plurality of navigation signals to base navigational information upon;
(d) setting the adaptive filter to one of the plurality of predetermined passband widths based upon the determined navigation signal to base navigation information upon.

### BRIEF DESCRIPTION OF THE DRAWINGS

Exemplary embodiments of the invention will now be described in conjunction with the following drawings, in which:

FIG. 1 illustrates a typical outline embodiment of the invention showing the feedback from software based DSP to the adaptive bandwidth filter.

FIG. 2 illustrates an exemplary embodiment of a filter providing adaptive bandwidth filter under software control.

### DETAILED DESCRIPTION OF EMBODIMENTS OF THE INVENTION

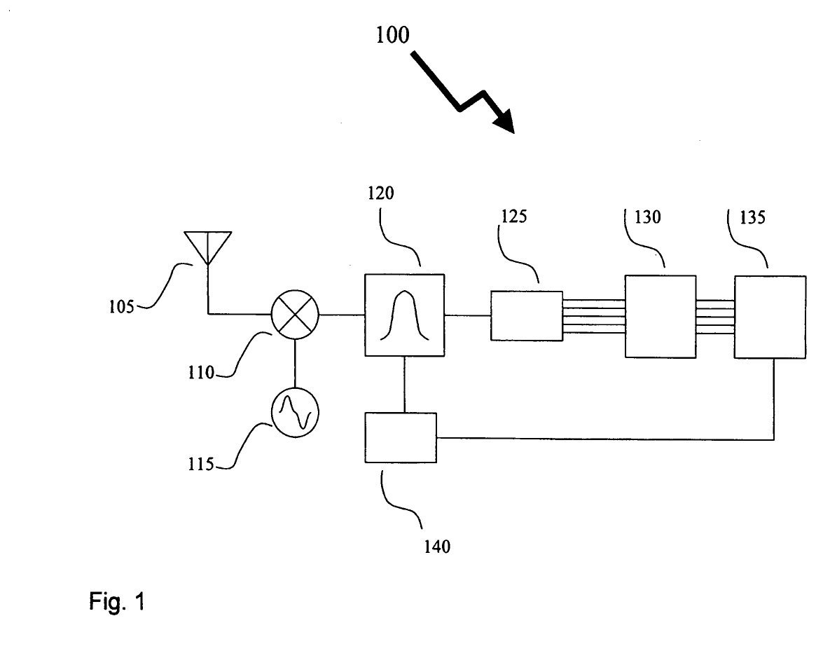

Shown in FIG. 1 is a receiver antenna 105 designed for the receipt of GNSS signals, for example at 1575.52 MHz as currently employed by GPS systems and as intended for the EU Galileo system. The received signal from the receiver antenna 105 is then mixed within an RF mixer 110, which is electrically coupled to a local oscillator 115. The IF down-converted signal from the RF mixer 110 is then coupled through the adaptive bandwidth filter 120 and converted to a digital representation by the sampling ADC 125. The digitized and down-converted IF signal is then fed-forward to the digital signal processing unit 130 which performs a front-end correlation function of the digitized IF signal. The result of the front-end correlation is then converted to a software based decision cluster 135, which decides which configuration to apply for the GNSS receiver front-end 100. Based upon the configuration selected the software provides a control signal to the adaptive filter control module 140 which provides the appropriate commands to the adaptive bandwidth filter 120.

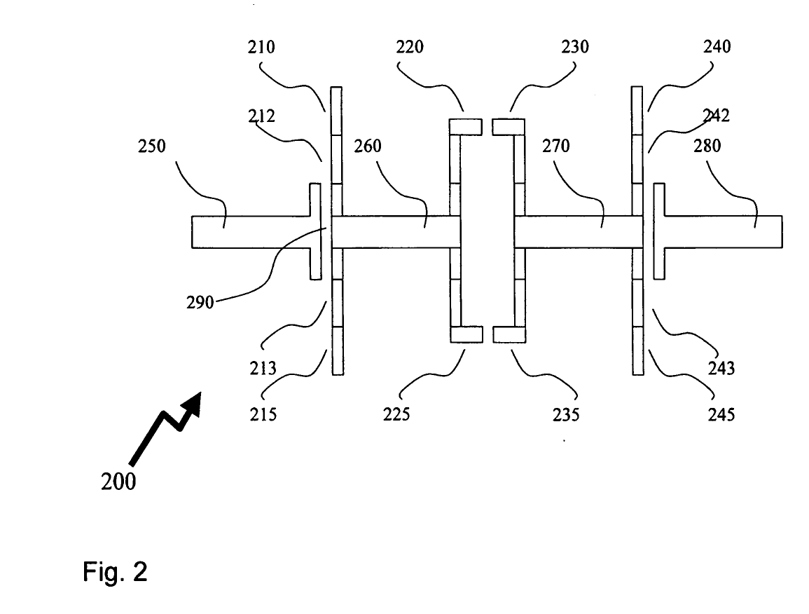

In FIG. 2 is illustrated an exemplary embodiment of an adaptive bandwidth filter 120 providing functionality such as that described with reference to FIG. 1 under software control.

Adaptive or tunable filters have typically focused on centre frequency agility in order to provide the filtering of a specific signal from a plurality of signals present within the microwave spectrum. As described previously, it is now desirable to manipulate the bandwidth without substantially affecting the microwave centre frequency. Amongst the different classes of such electronically tunable filters are those based upon semiconductor diode varactors in combination with resonators as they are compatible with monolithic microwave integrated circuits (MMICs), and capacitively coupled transmission lines (CCTL) such as that described in U.S. Pat. No. 5,153,542 “Multi-Dielectric Microstrip Filter” by Tai and Petersen, which are also compatible with MMICs, and are deployed as fixed filters. A gap, if inserted within a microstrip transmission line acts as a discontinuity, such as between transmission lines 250 and 260. This gap 290 is modelable as a series capacitor between two transmission lines, Cg, and a shunt capacitance, Cp, between the transmissions lines 250 and 260, and the ground plane, not shown for simplicity. However, the value of Cg is sometimes significant, resulting in a small gap separation for the gap 290 between the transmission lines such that fabrication variations represent a problem.

The addition of lateral extensions 210, 212, 213 and 215 if added to the second transmission line structure 260 adjacent to the gap 290 result in an increase in the gap capacitance without varying the gap separation of the gap 290. Actually the lateral extensions 210, 212, 213 and 215 result in an increase of the gap capacitance (Cg+2Cg′) and shunt capacitance (Cp+2 Cp′). In the adaptive bandwidth filter 200 shown here in the exemplary embodiment, two capacitively coupled resonators are coupled. The second resonator is formed from the third and fourth transmission lines 270 and 280, where again the gap has been modified by the lateral extensions 240, 242, 243 and 245.

Joining the two resonators is the resonator formed from a third gap, this gap between the transmission lines 260 and 270. The capacitance in this resonator is adjusted when the lateral extensions, shown as upper stubs 220 and 230 and lower stubs 225, 235 are employed, and adjusted. Adjusting the capacitance adjusts the individual resonant frequencies, either moving them away from a centre frequency to create a wider bandwidth or closer together to narrow the bandwidth. As a result, if the upper and lower stubs 220, 230 and 225 and 235 respectively are adjusted dynamically then the resulting adaptive bandwidth filter 200 has an approximately fixed centre frequency and variable bandwidth. Such a variation in the stubs is implementable, for example, by the use of MEMS or pin diodes.

In another embodiment of the invention, it is a further design constraint of the filter that the design operates with a relatively invariant propagation delay through the filter. Such an invariant propagation delay removes the possibility that different parts of the incoming signal appearing to arrive with different timing potentially resulting in an incorrect position reading for the GNSS user. Such a constraint imposes that the filter design be relatively simple with a frequency cut-off profile that is not too sharp.

As outlined in FIG. 1 the bandwidth of the adaptive bandwidth filter 120, shown in embodiment 200 in FIG. 2, is advantageously modified by software controlled decision making of the GNSS receiver front-end 100 and a simple dual resonator design such as shown in FIG. 2 allowing for electrical adjustment of the upper and lower stubs 220, 225, 230 and 235.

Numerous other embodiments may be envisaged without departing from the spirit or scope of the invention.

1. A method of reducing noise within a microwave receiver comprising;
providing an input port, the input port for receiving a microwave spectrum being noise dominated;
providing an output port, the output port for providing a modified microwave spectrum with substantially reduced noise;
providing an adaptive bandwidth filter; the adaptive bandwidth filter being coupled between the input port and output port, having at least a control port, for providing a variable passband bandwidth between predetermined minimum and maximum frequency values and having the variable passband bandwidth approximately centered about a constant centre frequency; and
providing a control signal to the at least a control port for varying the variable passband bandwidth of the adaptive bandwidth filter, the control signal determined in dependence upon a software decision process that comprises a correlation process, the correlation process extracting a microwave signal from below the noise level and received at the microwave input port, the control signal for maintaining the variable passband approximately centered about the constant centre frequency.

2. A method according to claim 1 wherein the constant centre frequency is 1575.42 MHz.

3. A method according to claim 1 wherein the predetermined minimum frequency value of the variable passband bandwidth is less than 2.5 MHz.

4. A method according to claim 1 wherein the predetermined maximum frequency value of the variable passband bandwidth is more than 4.0 MHz.

5. A circuit for isolating very low-level signals within a microwave receiver comprising;
an input port, the input port for receiving a microwave spectrum being noise dominated;
an output port, the output port for providing a modified microwave spectrum with substantially reduced noise;
a control port;
a control circuit and an adaptive bandwidth filter coupled between the input port and output port and having a control port for receiving a control signal from the control circuit, the control circuit and the adaptive bandwidth filter for in cooperation providing a variable passband having a bandwidth, the variable passband between predetermined minimum and maximum frequency values and centered about a centre frequency, the centre frequency maintained approximately constant.

6. A circuit according to claim 5 comprising a processor for defining the control signal using at least one of a software decision process and a correlation process performed upon the modified microwave spectrum.

7. A circuit according to claim 6 wherein in use the correlation process extracts a desired microwave signal from below the noise level at the microwave input port.

8. A circuit according to claim 5 wherein the centre frequency is 1575.42 MHz.

9. A circuit according to claim 5 wherein the minimum value of the variable passband bandwidth is less than 2.5 MHz.

10. A circuit according to claim 5 wherein the maximum value of the variable passband bandwidth is more than 4.0 MHz.

11. A method of recovering navigation signal information comprising;
providing a microwave receiver; the microwave receiver for receiving RF signals over at least a predetermined bandwidth from a navigation beacon, the navigation beacon providing a characteristic navigation signal of lower signal strength than the background noise power incident upon the microwave receiver;
providing an adaptive microwave filter; the adaptive microwave filter being electrically coupled to the microwave receiver and having an output port and a control port, the adaptive microwave filter for providing a controllably selectable filter passband around a fixed centre frequency, the fixed centre frequency being that of the navigation signal, where the controllably selectable filter passband is based on a control signal applied to the control port; and
providing a digital signal processing unit for correlating the output signal from the adaptive microwave filter to determine at least a characteristic of the navigation signal, the digital signal processing unit for providing the control signal to the control port of the adaptive microwave filter.

12. A process comprising:
(a) passing a microwave signal through an adaptive passband filter, to provide a filtered microwave signal, the adaptive passband filter supporting a plurality of predetermined passband widths;
(b) correlating the filtered microwave signal with a characteristic of a navigation signal;
(c) determining based upon the result of the correlation a first navigation signal to base navigational information upon; and
(d) setting the adaptive passband filter to one of the plurality of predetermined passband widths based upon the first navigation signal.

13. A process according to claim 12 comprising:
(e) repeating the steps (a) through (d) for at least a predetermined number of navigation signals, after a predetermined period of elapsed time since the last execution of steps (a) through (d).

14. A process according to claim 12 wherein (b) is adjusted in respect of electrical power consumption to execute the step based upon at least one of battery charge, machine status, user input and the electrical signal strength difference of the first navigation signal and noise.

15. A circuit according to claim 5, wherein the adaptive bandwidth filter is a dual resonator design.
